(19) United States
(12) Patent Application Publication
(10) Pub. No.: US 2019/0347687 A1
(43) Pub. Date: Nov. 14, 2019

(54) METHOD AND SYSTEM FOR PROVIDING REWARD FOR CONTENT THROUGH USERS

(71) Applicant: NAVER CORPORATION, Seongnam-si (KR)

(72) Inventors: Ilgu LEE, Seongnam-si (KR); JongHoon PARK, Seongnam-si (KR); Chang Yeop LEE, Seongnam-si (KR); Jaeman PARK, Seongnam-si (KR); Sung Min PARK, Seongnam-si (KR); Jaeyong SHIM, Seongnam-si (KR)

(21) Appl. No.: 16/409,388

(22) Filed: May 10, 2019

(30) Foreign Application Priority Data
May 10, 2018 (KR) 10-2018-0053538

(51) Int. Cl. G06Q 30/02

(52) U.S. Cl. CPC G06Q 30/0222; G06Q 30/0236; G06Q 30/0215

(57) ABSTRACT

A method of providing a reward for content may include providing a user of a shopping service or an advertising service with a power that is an ability to support content as a reward according to purchase; and providing a creator of content supported by the user with a reward of a differential value based on a power of the user as a reward according to support. A desired ratio of revenues acquired through the shopping service or the advertising service is determined as total financial resources required for the reward of the user and the reward of the creator.

### CROSS-REFERENCE TO RELATED APPLICATION(S)

This U.S. non-provisional application claims the benefit of priority under 35 U.S.C. § 119 to Korean Patent Application No. 10-2018-0053538 filed on May 10, 2018, in the Korean Intellectual Property Office (KIPO), the entire contents of which are incorporated herein by reference.

### BACKGROUND OF THE INVENTION

### Field of Invention

One or more example embodiments of the present invention relate to technology for providing a reward for content.

### Description of Related Art

Due to the current appearance of various types of information technology (IT) devices and the increasing use thereof, advertisements for users of the IT devices are on the explosive increase and revenues acquired from such advertising are also rising greatly.

For example, a system for distributing earnings from advertisement that may determine a level of contribution made for advertising based on a number of times a plurality of user clients click on an advertisement posted to a website operated by a plurality of web servers and may differentially pay advertising charges to the plurality of web servers based on the determined level of contribution, and a service method thereof are disclosed in Korean Patent Registration No. 10-0696286, registered on Mar. 12, 2007.

Currently, an advertising media-oriented service inserts an advertisement into a content creation of a creator and distributes a portion of advertising revenues to the content creator in response to an occurrence of the advertising revenues. In this case, a content creation with a context difficult to match with an advertisement may not share such revenues although the creation has a service value many users like. The content creator may attempt to increase his or her share of the revenue through mutual assistance with acquaintances or through actions of self-clicks or exposures. In this case, the advertising effect of an advertiser may decrease, which may cause a continuity issue, i.e., a disconnect between content creation and advertisement revenue.

Regardless of advertising, a content creator may be rewarded based on a contribution to a service, such as a reward for a webtoon artist or a reward for an excellent blogger. However, in such a case, a total amount of revenues and an amount of revenues to be shared may be ambiguous.

### BRIEF SUMMARY OF THE INVENTION

One or more example embodiments provide a method and system that may provide a creator of content with a reward through a user of an advertising service or a shopping service.

According to an aspect of at least one example embodiment, there is provided a computer-implemented method of providing a reward for content, the method including providing a user of a shopping service or an advertising service with a power that is an ability to support content as a reward according to purchase; and providing a creator of content supported by the user with a reward of a differential value based on a power of the user as a reward according to support. A desired ratio of revenues acquired through the shopping service or the advertising service is determined as total financial resources required for the reward of the user and the reward of the creator.

The providing of the power may include providing the user with a desired ratio of mileage and the power based on a contribution of the user that is made in the shopping service or the advertising service.

The providing of the reward may include providing a reward of a relatively great value according to an increase in the power of the user to be proportional to the power of the user in response to the user supporting the content through evaluation on the content.

The providing of the reward may include dividing a total power of the user by N and transferring the divided power to a creator of each of N pieces of contents in response to the N pieces of contents being evaluated by the user during a desired period of time.

The providing of the reward may include supporting the content by donating mileage of the user.

The content reward providing method may further include converting a reward value of the creator provided through support of the user to a reward amount based on a preset exchange ratio.

The exchange ratio of the reward amount to the reward value may be determined based on the determined total financial resources.

The exchange ratio of the reward amount to the reward value may be determined based on a ratio of the determined total finance resources to a sum of reward values of entire creators.

The converting may include converting the reward amount to a power that is an ability to support content of another creator.

The converting of the power may include converting the reward amount to the power by applying at least one of the exchange ratio and a conversion speed as a penalty.

According to an aspect of at least one example embodiment, there is provided a non-transitory computer-readable storage medium storing instructions that, when executed by a processor, cause the processor to perform the content reward providing method.

According to an aspect of at least one example embodiment, there is provided a computer-implemented system for providing a reward for content, the system including a memory; and at least one processor configured to connect to the memory and to execute computer-readable instructions included in the memory. The at least one processor includes a user reward provider configured to provide a user of a shopping service or an advertising service with a power that is an ability to support content as a reward according to purchase; and a content reward provider configured to provide a creator of content supported by the user with a reward of a differential value based on a power of the user as a reward according to support, and a desired ratio of revenues acquired through the shopping service or the advertising service is determined as total financial resources required for the reward of the user and the reward of the creator.

According to some example embodiments, it is possible to prepare a sufficient amount of financial resources to be distributed to a creator and to enable users of an advertising service or a shopping service to evaluate a value of content by generating a model that connects advertising or shopping business to support of content business creators through the users of the advertising service or the shopping service.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

Example embodiments will be described in more detail with regard to the figures, wherein like reference numerals refer to like parts throughout the various figures unless otherwise specified, and wherein:

FIG. 1 illustrates an example of a network environment according to one example embodiment;

FIG. 2 illustrates an example of an electronic device and a server according to one example embodiment;

FIG. 3 illustrates an example of components includable in a processor of a server according to one example embodiment;

FIG. 4 is a flowchart illustrating a method performed by a server according to one example embodiment; and

FIG. 5 is a flowchart illustrating a process of providing a reward to a creator of content through a user of an advertising service or a shopping service according to one example embodiment.

It should be noted that these figures are intended to illustrate the general characteristics of methods and/or structure utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments.

### DETAILED DESCRIPTION OF THE INVENTION

One or more example embodiments will be described in detail with reference to the accompanying drawings. Example embodiments, however, may be embodied in various different forms, and should not be construed as being limited to only the illustrated embodiments. Rather, the illustrated embodiments are provided as examples so that this disclosure will be thorough and complete, and will fully convey the concepts of this disclosure to those skilled in the art. Accordingly, known processes, elements, and techniques, may not be described with respect to some example embodiments. Unless otherwise noted, like reference characters denote like elements throughout the attached drawings and written description, and thus descriptions will not be repeated.

Although the terms “first,” “second,” “third,” etc., may be used herein to describe various elements, components, regions, layers, and/or sections, these elements, components, regions, layers, and/or sections, should not be limited by these terms. These terms are only used to distinguish one element, component, region, layer, or section, from another region, layer, or section. Thus, a first element, component, region, layer, or section, discussed below may be termed a second element, component, region, layer, or section, without departing from the scope of this disclosure.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

As used herein, the singular forms “a,” “an,” and “the,” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups, thereof. As used herein, the term “and/or” includes any and all combinations of one or more of the associated listed products. Expressions such as “at least one of,” when preceding a list of elements, modify the entire list of elements and do not modify the individual elements of the list. Also, the term “exemplary” is intended to refer to an example or illustration.

When an element is referred to as being “on,” “connected to,” “coupled to,” or “adjacent to,” another element, the element may be directly on, connected to, coupled to, or adjacent to, the other element, or one or more other intervening elements may be present. In contrast, when an element is referred to as being “directly on,” “directly connected to,” “directly coupled to,” or “immediately adjacent to,” another element there are no intervening elements present.

Unless otherwise defined, all terms (including technical and scientific terms) used herein have the same meaning as commonly understood by one of ordinary skill in the art to which example embodiments belong. Terms, such as those defined in commonly used dictionaries, should be interpreted as having a meaning that is consistent with their meaning in the context of the relevant art and/or this disclosure, and should not be interpreted in an idealized or overly formal sense unless expressly so defined herein.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particular manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

Units and/or devices according to one or more example embodiments may be implemented using hardware and/or a combination of hardware and software. For example, hardware devices may be implemented using processing circuitry such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor), Central Processing Unit (CPU), a controller, an arithmetic logic unit (ALU), a digital signal processor, a microcomputer, a microprocessor, etc., the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable storage mediums, including the tangible or non-transitory computer-readable storage media discussed herein.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive, solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blue-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as one computer processing device; however, one skilled in the art will appreciate that a hardware device may include multiple processing elements and multiple types of processing elements. For example, a hardware device may include multiple processors or a processor and a controller. In addition, other processing configurations are possible, such as parallel processors.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

Hereinafter, example embodiments will be described with reference to the accompanying drawings.

The example embodiments relate to technology for providing a reward for content, and more particularly, to a model that connects shopping/advertising businesses to support of content creators through users of the content.

The example embodiments disclosed herein may implement a model that connects shopping/advertising to content creation in such a manner that a user of an advertising service or a shopping service evaluates the content of a content creator or makes a donation for the content through a reward according to a service use, and may achieve many advantages in terms of efficiency, service continuity, enhancement in quality of content, and enhancement in quality of service (QoS).

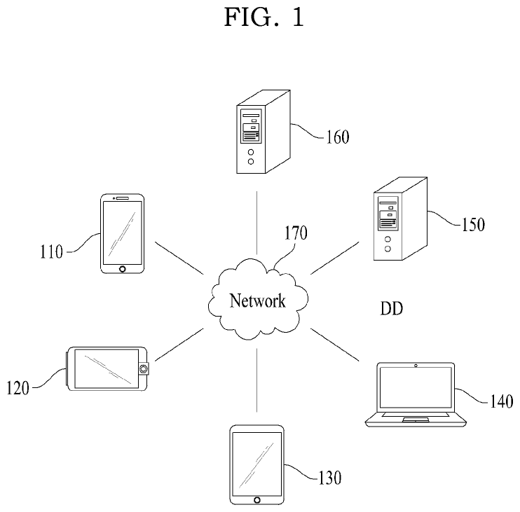

FIG. 1 is a diagram illustrating an example of a network environment according to one example embodiment. Referring to FIG. 1, the network environment includes a plurality of electronic devices 110, 120, 130, and 140, a plurality of servers 150 and 160, and a network 170. FIG. 1 is provided as an example only and thus, a number of electronic devices and/or a number of servers are not limited thereto.

Each of the plurality of electronic devices 110, 120, 130, and 140 may be a fixed terminal or a mobile terminal configured as a computer apparatus. For example, the plurality of electronic devices 110, 120, 130, and 140 may be a smartphone, a mobile phone, a navigation, a computer, a laptop computer, a digital broadcasting terminal, a personal digital assistant (PDA), a portable multimedia player (PMP), a tablet personal computer (PC), a game console, a wearable device, an Internet of things (IoT) device, a virtual reality (VR) device, and an augmented reality (AR) device. For example, although FIG. 1 illustrates a shape of a smartphone as an example of the electronic device 110, the electronic device 110 may refer to one of various physical computer systems capable of communicating with other electronic devices 120, 130, and 140, and/or the servers 150 and 160 over the network 170 in a wired communication manner or in a wireless communication manner.

The communication scheme is not particularly limited and may include a communication method using a near field communication between devices as well as a communication method using a communication network, for example, a mobile communication network, the wired Internet, the wireless Internet, a broadcasting network, etc., which may be included in the network 170. For example, the network 170 may include at least one of network topologies that include, for example, a personal area network (PAN), a local area network (LAN), a campus area network (CAN), a metropolitan area network (MAN), a wide area network (WAN), a broadband network (BBN), and the Internet. Also, the network 170 may include at least one of network topologies that include a bus network, a star network, a ring network, a mesh network, a star-bus network, a tree or hierarchical network, and the like. However, it is only an example and the example embodiments are not limited thereto.

Each of the servers 150 and 160 may be configured as a computer apparatus or a plurality of computer apparatuses that provides instructions, codes, files, contents, services, and the like through communication with the plurality of electronic devices 110, 120, 130, and 140 over the network 170. For example, the server 150 may be a system that provides a first service to the plurality of electronic devices 110, 120, 130, and 140 connected over the network 170. The server 160 may be a system that provides a second service to the plurality of electronic devices 110, 120, 130, and 140 connected over the network 170. In detail, the server 150 may provide, as the first service, a service, for example, an advertising service or a shopping service, desired by a corresponding application through the application as the computer program installed and executed on the plurality of electronic devices 110, 120, 130, and 140. As another example, the server 160 may provide, as the second service, a service that distributes a file for installing and executing the application to the plurality of electronic devices 110, 120, 130, and 140.

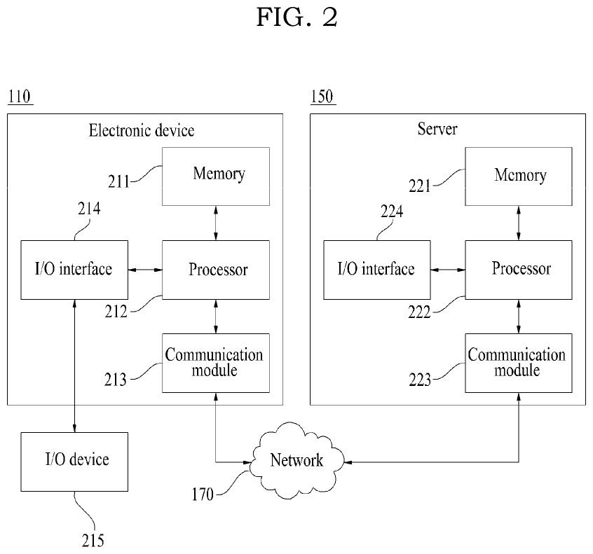

FIG. 2 is a block diagram illustrating an example of a configuration of an electronic device and a server according to at least one example embodiment. FIG. 2 illustrates a configuration of the electronic device 110 as an example for a single electronic device and illustrates a configuration of the server 150 as an example for a single server. The same or similar components may be applicable to other electronic devices 120, 130, and/or 140, or the server 160, and also to still other electronic devices or still other servers.

Referring to FIG. 2, the electronic device 110 may include a memory 211, a processor 212, a communication module 213, and an input/output (I/O) interface 214, and the server 150 may include a memory 221, a processor 222, a communication module 223, and an I/O interface 224. The memory 211, 221 may include a permanent mass storage device, such as random access memory (RAM), a read only memory (ROM), a disk drive, a solid state drive (SSD), and a flash memory, as a non-transitory computer-readable storage medium. The permanent mass storage device, such as ROM, SSD, flash memory, and disk drive, may be included in the electronic device 110 or the server 150 as a permanent storage device separate from the memory 211, 221. Also, an OS or at least one program code, for example, a code for a browser installed and executed on the electronic device 110 or an application installed and executed on the electronic device 110 to provide a specific service, may be stored in the memory 211, 221. Such software components may be loaded from another non-transitory computer-readable storage medium separate from the memory 211, 221. The other non-transitory computer-readable storage medium may include a non-transitory computer-readable storage medium, for example, a floppy drive, a disk, a tape, a DVD/CD-ROM drive, a memory card, etc. According to other example embodiments, software components may be loaded to the memory 211, 221 through the communication module 213, 223, instead of, or in addition to, the non-transitory computer- readable storage medium. For example, at least one program may be loaded to the memory 211, 221 based on a program, for example, the application, installed by files provided over the network 170 from developers or a file distribution system, for example, the server 160, which provides an installation file of the application.

The processor 212, 222 may be configured to process computer-readable instructions of a computer program by performing basic arithmetic operations, logic operations, and I/O operations. The computer-readable instructions may be provided from the memory 211, 221 or the communication module 213, 223 to the processor 212, 222. For example, the processor 212, 222 may be configured to execute received instructions in response to the program code stored in the storage device, such as the memory 211, 221.

The communication module 213, 223 may provide a function for communication between the electronic device 110 and the server 150 over the network 170, and may provide a function for communication with another electronic device, for example, the electronic device 120 or another server, for example, the server 160. For example, the processor 212 of the electronic device 110 may transfer a request created based on a program code stored in the storage device, such as the memory 211, to the server 150 over the network 170 under control of the communication module 213. Inversely, a control signal, an instruction, content, a file, etc., provided under control of the processor 222 of the server 150 may be received at the electronic device 110 through the communication module 213 of the electronic device 110 by going through the communication module 223 and the network 170. For example, a control signal, an instruction, content, a file, etc., of the server 150 received through the communication module 213 may be transferred to the processor 212 or the memory 211, and content, a file, etc., may be stored in a storage medium further includable in the electronic device 110.

The I/O interface 214 may be a device used for interface with an I/O device 215. For example, an input device may include a device, such as a keyboard, a mouse, and a microphone, and an output device may include a device, such as a display, a speaker, and a haptic feedback device. As another example, the I/O interface 214 may be a device for interface with an apparatus in which an input function and an output function are integrated into a single function, such as a touchscreen. The I/O device 215 may be configured as a single device with the electronic device 110. Also, the I/O interface 224 of the server 150 may be a device for interface with an apparatus (not shown) for input or output that may be connected to the server 150 or included in the server 150. In detail, based on the processing instructions of the computer program loaded to the memory 211, the processor 212 of the electronic device 110 may display a service screen configured using data provided from the server 150 or the electronic device 120, or may display content on a display through the I/O interface 214.

According to other example embodiments, the electronic device 110 and the server 150 may include a number of components greater or less than a number of components shown in FIG. 2. For example, the electronic device 110 may include at least a portion of the I/O device 215, or may further include other components, for example, a transceiver, a global positioning system (GPS) module, a camera, a variety of sensors, a database (DB), and the like. In detail, if the electronic device 110 is a smartphone, the electronic device 110 may be configured to further include a variety of components, for example, an accelerometer sensor, a gyro sensor, a camera module, various physical buttons, a button using a touch panel, an I/O port, a vibrator for vibration, etc., which are generally included in the smartphone.

Hereinafter, examples of a method and system for providing a reward for content through a user of an advertising service or a shopping service will be described.

The term “content” used herein refers to a creation created by a creator, such as, a variety of posts published online that include, for example, webtoon, news, and blog, and inclusively indicates any content that may be rewarded using various supporting methods.

The example embodiments may implement a model that connect a content platform to an advertising/shopping service platform, and may provide a sufficient amount of financial resources to be distributed to the creator of content through the model. In particular, the value of a creation may be evaluated by a user of an advertising service or a shopping service, and mutual assistance with acquaintances and a self-abusing may be prevented from occurring when the user evaluates the corresponding content.

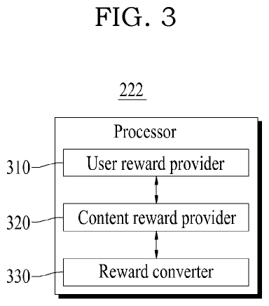

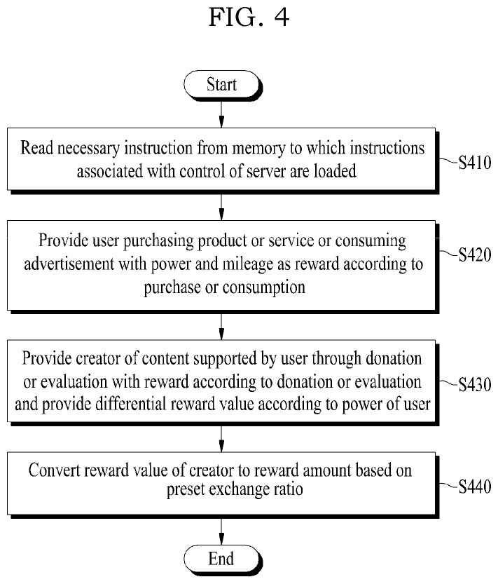

FIG. 3 illustrates an example of components includable in the processor 222 of the server 150 according to one example embodiment, and FIG. 4 is a flowchart illustrating an example of a method performed by the server 150 according to one example embodiment.

The server 150 according to the example embodiment may provide a reward for content through users by implementing a model that connects shopping/advertising business to support the content creators. For example, the server 150 may function as a platform that provides an advertising service or a shopping service to the plurality of electronic devices 110, 120, 130, and/or 140 that are clients or users. The server 150 may provide the advertising service or the shopping service through interaction with an application installed on the electronic devices 110, 120, 130, and/or 140.

Referring to FIG. 3, the processor 222 of the server 150 may include a user reward provider 310, a content reward provider 320, and a reward converter 330 as components to perform a content reward providing method of FIG. 4. Depending on example embodiments, the components of the processor 222 may be included in or excluded from the processor 222. Also, depending on example embodiments, the components of the processor 222 may be separate or merged for functional representation of the processor 222.

The processor 222 and the components of the processor 222 may control the server 150 to perform operations S410 to S440 included in the content reward providing method of FIG. 4. For example, the processor 222 and the components of the processor 222 may be configured to execute an instruction according to a code of at least one program or a code of an OS included in the memory 221.

Here, the components of the processor 222 may be representations of different functions of the processor 222 that are performed by the processor 222 in response to an instruction provided from a program code stored in the server 150. For example, the user reward provider 310 may be used as a functional representation of the processor 222 to control the server 150 to provide a reward to a user of an advertising service or a shopping service in response to the instruction.

Referring to FIG. 4, in operation S410, the processor 222 may read the necessary instruction from the memory 221 to which instructions associated with control of the server 150 are loaded. In this case, the read instruction may include an instruction for controlling the processor 222 to perform the following operations S420 to S440.

In operation S420, the user reward provider 310 may provide a user purchasing a product/service online or consuming an advertisement online with a power, e.g., represented by a numerical value, that is an ability to support content with mileage in a rewards program as a reward according to the purchase of the product/service or consumption of the advertisement. That is, in response to consuming the advertisement, such as by viewing or clicking the advertisement, through an advertising service or purchasing the product or the service through an online shopping service, the user reward provider 310 may provide the user of the corresponding service with mileage and, in this instance, may additionally provide the user with the power to support the content creator in addition to the mileage. In the case of advertising, to prevent abusing, such as abusive clicks, the user reward provider 310 may provide a reward only when a corresponding click on the advertisement actually leads to a purchase of the product or the service. Here, commercial transactions through the advertising service or the shopping service may provide financial resources necessary for rewarding a user and a creator, and the reward and the power to be provided to the user may also be maintained or increase as the advertising service or the shopping service is maintained or grows.

In operation S430, the content reward provider 32 may provide a creator of content supported by the user of the advertising service or the shopping service through donation or evaluation with a reward and, in this instance, may provide a differential reward value according to the power of the corresponding user. The content of the creator may be rewarded according to the direct donation and evaluation. The user may donate his or her own mileage with respect to the content or may evaluate the content based on the power of the user. Here, an evaluation value may be differentially determined based on the power of the user that evaluates the content. The content reward provider 320 may provide the creator of the content with mileage as the reward according to the donation or the evaluation of the user. A reward value for the content creator may be provided to be proportional to the power of the user that supports the content of the creator. For example, if a user i with a power of 1 enters ‘Like’ with respect to content a of a creator A, the content reward provider 320 may provide a reward with a value of 1. If a user ii with a power of 2 enters ‘Like’ with respect to the content a of the creator A, the content reward provider may provide a reward with a value of 2. The value of power may be determined at a server and thereby accumulated in response to consuming an advertisement or purchasing a product/service. For example, the power of a user may be accumulated in response to consuming an advertisement or purchasing a product or a service. Therefore, the more advertisement is consumed, or the more the product or the service is purchased, the value of power is determined to be proportional thereto. If a power level of a user donating or evaluating the corresponding content is greater, the more reward value is provided to the creator of the corresponding content.

In operation S440, the reward converter 330 may convert the reward value of the creator supported through the donation or the evaluation of the user to a reward amount based on a preset exchange ratio. A reward value for the creation may be converted to money, i.e., reward amount, having a practical value and thereby be provided to the creator. A relationship between the reward value for the creator and actual money provided, that is, paid to the creator may be determined such that an amount of money may increase according to an increase in the reward value. In particular, a ratio or a scale between the reward value for the content creator and money actually paid to the content creator may be automatically adjusted based on total financial resources. For example, a desired ratio of revenues made through the advertising service or the shopping service, for example, 60% of revenues made through blog space, may be determined as the total financial resources. An exchange ratio of a reward amount to a reward value 1 and may be determined as a ratio of <total financial resources/sum of reward values of all creations>. That is, an exchange ratio of the reward amount to the reward value for the content creator may be determined based on the total financial resources. Here, the total financial resources may be promised and published in advance. When an additional financial resource is required in addition to the published total financial resources, the additional resource may be additionally determined in a form of a promotion. In addition, transparent disclosure of, for example, targets to be supported and rewarded, a value standard, and a conversion standard, enables the user and the content creator to predict the effect of their actions.

The reward converter 330 may also convert the reward amount for the content creator to a power that is an ability to support content of another content creator. The reward converter 330 may apply a penalty based on at least one of an exchange ratio and a conversion speed when converting money to the power. For example, the reward converter 330 may convert the reward amount to the power based on the exchange ratio of less than 1.0. Here, for example, an amount of money corresponding to 1 won may be converted to the power of 0.5. As another example, the reward converter 330 may apply the penalty based on the conversion speed by applying a latency occurring when the reward amount is converted to the power. For example, 1 day may be set to be used when money is converted to the power, and conversely, the power may be set to be immediately converted to money. As described above, since the penalty is applied using at least one of the exchange ratio and the conversion speed when exchanging money to the power, it is possible to effectively prevent an abuse situation where content creators increase their powers through mutual assistance.

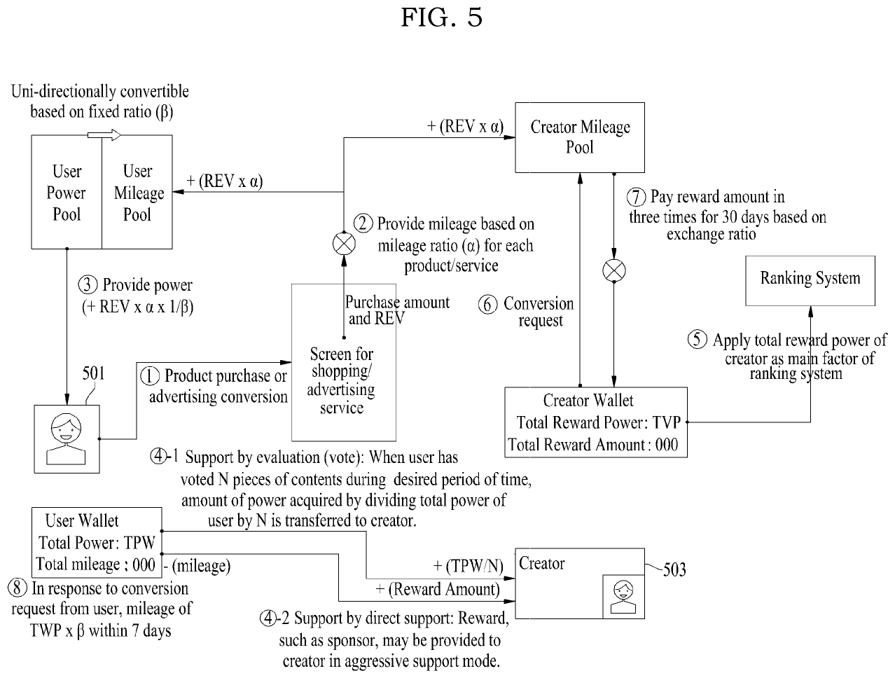

FIG. 5 is a flowchart illustrating an example of a process of providing a reward to a creator of content through a user of an advertising service or a shopping service according to one example embodiment.

\textcircled{1} A user 501 may purchase a product or a service through an online shopping service or may purchase the product or the service by going through advertising conversion through the online advertising service. As used herein, “conversion” refers to an action of a client (user) on advertising. The conversion may correspond to login, sign-up, page view, download, or other various communications,

\textcircled{2} The processor 222 may provide the user 501 with a reward based on a level of contribution of the user 501 through the shopping service or the advertising service. For example, the level of contribution may be determined based on a purchase amount of the product or the service purchased by the user 501 or advertising revenues according to advertising consumption of the user 501. For example, the processor 222 may provide mileage (=REV×α) according to the purchase amount (REV) of the product or the service purchased by the user 501 and a mileage ratio (α), which is predefined and set as a default, as a reward according to the product/service purchase or advertising conversion of the user 501.

\textcircled{3} The processor 222 may provide the user 501 with a power capable of supporting content as well as the mileage as the reward according to the product/service purchase or advertising conversion of the user 501. For example, a power of the user 501 may be determined based on a fixed ratio β that is determined in advance and set as a default value with respect to the mileage according to the product/service purchase or advertising conversion, and may be represented as REV×α×(1/β.

\textcircled{4} Methods of supporting a creator 503 of content, such as webtoon, news, and blog, may include two support methods, for example, a support method by an evaluation, such as through voting, and a support method by a direct mileage donation.

\textcircled{4}-1 The user 501 may support good quality content and the creator 503 of the content through the evaluation, such as by voting. When the user 501 has voted N pieces of contents during a desired period of time, the user 501 may transfer, to the creator 503 an amount of power acquired by dividing a total power (TPW) of the user 501 by N. The effect of the votes may be proportional to the power of the user 501 and the content creator 503 may be periodically rewarded with mileage to be proportional to a sum of powers acquired through voting. Here, in the case of voting, the power of the user 501 does not disappear, that is, the user 501 does not have a financial loss. The user 501 that proceeds with substantial purchase has a great vote influence, which may lead to reducing abusing associated with content ranking.

\textcircled{4}-2 Alternatively or in addition, the user 501 may transfer mileage of the user 501 to the content creator 503 as a direct support for the creator 503. This support may be regarded as a further aggressive support mode than through voting. Accordingly, the mileage of the user 501 may be divided by a desired period of time and thereby provided to the creator 503, such as a regular sponsor. For example, mileage saved for a corresponding month may be transferred to a content creator on the last day of every month. The desired period of time refers to a period for the regular payment and may be designed by the user or may be designated and set as a default value at the server.

\textcircled{5} The processor 222 may apply the reward power of the content creator 503 that is provided through the support of the user 501 as one of quality ranking factors of a ranking system that provides ranking information of content.

\textcircled{6}\textcircled{7} In response to a conversion request from the content creator 503, the processor 222 may convert a reward amount accumulated by the content creator based on a preset exchange ratio and may provide the converted reward amount to the content creator. For example, the reward amount exchange ratio may be determined by (total accumulated reward amount/total accumulated reward power of content creator). The exchange ratio may be set at a ratio at which no issue arises in terms of financial resources although the total reward power reserved through the vote of the user 501 is converted as the reward amount for the creator 503 at a time. Here, a predetermined (or, alternatively, desired) unit may be truncated to prevent confusion from occurring due to a change in the exchange ratio. By paying the reward amount of the content creator 503 several times within a desired period of time, for example, three times within 30 days, rather than in a lump-sum payment mode, it is possible to prevent a sudden change in a main ranking factor. As another example, the processor 222 may apply a penalty according to a conversion speed by applying a latency when the power rewarded to the content creator 503 is converted to a reward amount. This is to control a sudden change in rankings in a structure in which the power itself is reflected in the ranking system.

\textcircled{8} The processor 222 may convert the power of the user 501 to mileage based on the fixed ratio β in response to a request from the user 501. To encourage the support for the creator 503, the processor 222 may convert the power to the mileage in a grace period, for example, 7 days in response to the conversion request from the user 501.

According to some example embodiments, by generating a model that connects shopping/advertising business to support of content creators through users, it is possible to aggressively enhance matching and exposure of advertisements for achieving user satisfaction or return on investment (ROI) enhancement on an advertiser side. Also, instead of merely focusing on generating advertising revenue, a creator may create content capable of satisfying users, which may lead to improvements in the quality of the creation. There is a continuity that financial resources are maintained or grow continuously as an advertising service or a shopping service is maintained or grows. Also, enhancement in the quality of service (QoS) of the creation may increase a probability that the user may use the advertising service or the shopping service, which may contribute to the growth of the advertising service or the shopping service. In this manner, a virtuous circle may be maintained.

The power of the user may be available even in a field aside from a revenue distribution. For example, a quality index of an advertisement users likewise may increase and advertising cost may be discounted. Here, a level of effect may vary based on the power level of the user. The power of the user may be used to evaluate the quality of shopping review. Also, the power of the user may be used to differentiate the benefit for the user. For example, in the case of a user having a relatively great power, a differential mileage ratio may be applied for the user when the user purchases a product or a service.

The foregoing description has been provided for purposes of illustration and description. It is not intended to be exhaustive or to limit the disclosure. Individual elements or features of a particular example embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method of providing a reward for content, the method comprising:
providing a user of a shopping service or an advertising service with a power represented by a numerical value to support content as a reward according to purchase; and
providing a creator of content supported by the user with a reward of a differential value based on the power of the user,
wherein a desired ratio of revenues acquired through the shopping service or the advertising service is determined as total financial resources required for the reward of the user and the reward of the creator.

2. The method of claim 1, wherein the providing of the power comprises providing the user with a desired ratio of mileage and the power based on a contribution of the user that is made in the shopping service or the advertising service.

3. The method of claim 1, wherein the providing of the reward comprises providing a reward according to an increase in the power of the user to be proportional to the power of the user in response to the user supporting the content through evaluation on the content.

4. The method of claim 1, wherein the providing of the reward comprises dividing a total power of the user by N and transferring the divided power to a creator of each of N pieces of contents in response to the N pieces of contents being evaluated by the user during a desired period of time.

5. The method of claim 2, wherein the providing of the reward comprises supporting the content by donating mileage of the user.

6. The method of claim 1, further comprising:
converting a reward value of the creator provided through support of the user to a reward amount based on a preset exchange ratio.

7. The method of claim 6, wherein the exchange ratio of the reward amount to the reward value is determined based on the determined total financial resources.

8. The method of claim 6, wherein the exchange ratio of the reward amount to the reward value is determined based on a ratio of the determined total finance resources to a sum of reward values of entire creators.

9. The method of claim 6, wherein the converting comprises converting the reward amount to a power that is an ability to support content of another creator.

10. The method of claim 9, wherein the converting of the power comprises converting the reward amount to the power by applying at least one of the exchange ratio and a conversion speed as a penalty.

11. A non-transitory computer-readable storage medium storing instructions that, when executed by a processor, cause the processor to perform the method of claim 1.

12. A computer-implemented system for providing a reward for content, the system comprising:
a memory; and
at least one processor configured to connect to the memory and to execute computer-readable instructions included in the memory,
wherein the at least one processor comprises:
a user reward provider configured to provide a user of a shopping service or an advertising service with a power represented by a numerical value to support content as a reward according to purchase; and
a content reward provider configured to provide a creator of content supported by the user with a reward of a differential value based on the power of the user, and
a desired ratio of revenues acquired through the shopping service or the advertising service is determined as total financial resources required for the reward of the user and the reward of the creator.

13. The system of claim 12, wherein the user reward provider is configured to provide the user with a desired ratio of mileage and the power based on a contribution of the user that is made in the shopping service or the advertising service.

14. The system of claim 12, wherein the content reward provider is configured to provide a reward according to an increase in the power of the user to be proportional to the power of the user in response to the user supporting the content through evaluation on the content.

15. The system of claim 12, wherein the content reward provider is configured to divide a total power of the user by N and to transfer the divided power to a creator of each of N pieces of contents in response to the N pieces of contents being evaluated by the user during a desired period of time.

16. The system of claim 13, wherein the content reward provider is configured to support the content by donating mileage of the user.

17. The system of claim 12, wherein the at least one processor further comprises:
a reward converter configured to convert a reward value of the creator provided through support of the user to a reward amount based on a preset exchange ratio.

18. The system of claim 17, wherein the exchange ratio of the reward amount to the reward value is determined based on the determined total financial resources.

19. The system of claim 17, wherein the reward converter is configured to convert the reward amount to a power that is an ability to support content of another creator.

20. The system of claim 19, wherein the reward converter is configured to convert the reward amount to the power by applying at least one of the exchange ratio and a conversion speed as a penalty.
